(19) United States
(12) Patent Application Publication
(10) Pub. No.: US 2020/0338762 A1
(43) Pub. Date: Oct. 29, 2020

(54) HORIZONTAL ARTICULATED ROBOT

(71) Applicant: FANUC CORPORATION, Yamanashi (JP)

(72) Inventor: Hideyuki WATANABE, Yamanashi (JP)

(73) Assignee: FANUC CORPORATION, Yamanashi (JP)

(21) Appl. No.: 16/807,470

(22) Filed: Mar. 3, 2020

(30) Foreign Application Priority Data
Apr. 24, 2019 (JP) 2019-082854

(51) Int. Cl. B25J 19/00; B25J 9/00; B25J 9/04; B25J 18/00

(52) U.S. Cl. CPC B25J 19/0091; B25J 18/00; B25J 9/042; B25J 9/0009

(57) ABSTRACT

A horizontal articulated robot includes: a base; a first arm that is supported by the base so as to be pivotable in a horizontal direction; a second arm that is supported by the first arm so as to be pivotable in the horizontal direction; a shaft that is supported by the second arm so as to be linearly movable in a vertical direction along a longitudinal axis; a stopper that is attached to the shaft and that restricts the movement of the shaft in the vertical direction within a movable range; and a buffering member provided in the second arm, wherein the buffering member is disposed between the stopper and a counterpart member that is provided in the second arm and that faces the stopper in the vertical direction, and buffers an impact exerted on the counterpart member from the stopper.

### CROSS-REFERENCE TO RELATED APPLICATIONS

This application is based on Japanese Patent Application No. 2019-082854, the content of which is incorporated herein by reference.

### FIELD

The present invention relates to a horizontal articulated robot.

### BACKGROUND

In the related art, there is a known horizontal articulated robot including: a base; a first arm supported by the base so as to be pivotable in the horizontal direction; a second arm supported by the first arm so as to be pivotable in the horizontal direction; and a shaft supported by the second arm so as to be movable in the vertical direction (for example, see Japanese Unexamined Patent Application, Publication No. 2015-077649, and Japanese Unexamined Patent Application, Publication No. 2009-095937). A stopper for restricting the movement of the shaft within a prescribed range is attached to an end portion of the shaft. In addition, there is a known robot including a buffering mechanism that buffers an impact when coming into contact with an object (for example, see Japanese Unexamined Patent Application, Publication No. 2016-172296, and Japanese Unexamined Patent Application, Publication No. 2018-086703).

### SUMMARY

An aspect of the present disclosure is directed to a horizontal articulated robot including: a base; a first arm that is supported by the base so as to be pivotable in a horizontal direction; a second arm that is supported by the first arm so as to be pivotable in the horizontal direction; a shaft that is supported by the second arm so as to be linearly movable in a vertical direction along a longitudinal axis; a stopper that is attached to the shaft and that restricts a movement of the shaft in the vertical direction within a movable range; and a buffering member provided in the second arm, wherein the buffering member is disposed between the stopper and a counterpart member that is provided in the second arm and that faces the stopper in the vertical direction, and buffers an impact exerted on the counterpart member from the stopper.

### BRIEF DESCRIPTION OF DRAWINGS

FIG. 1 is a configuration diagram of a horizontal articulated robot according to an embodiment of the present invention.

FIG. 2 is a partially enlarged view showing an example of a securing position of an upper-side buffering member.

FIG. 3 is a partially enlarged view showing an example of a securing position of a lower-side buffering member.

FIG. 4 is a perspective view of a stopper.

FIG. 5 is a diagram showing an example of the shape of the buffering member.

FIG. 6 is a diagram showing another example of the shape of the buffering member.

FIG. 7 is a diagram showing another example of the shape of the buffering member.

FIG. 8 is a partially enlarged view showing another example of the securing position of the upper-side buffering member.

FIG. 9 is a partially enlarged view showing another example of the securing position of the lower-side buffering member.

FIG. 10 is a perspective view of a modification of the buffering member.

FIG. 11 is a perspective view of another modification of the buffering member.

### DETAILED DESCRIPTIOIN

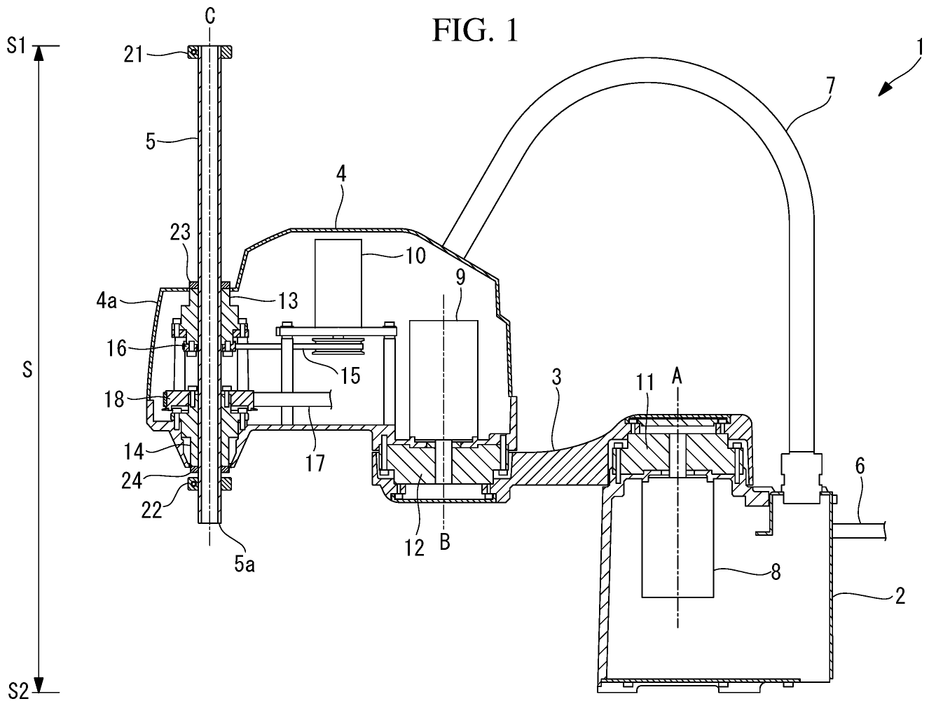

A horizontal articulated robot 1 according to an embodiment of the present invention will be described below with reference to the drawings. As shown in FIG. 1, the horizontal articulated robot 1 includes: a base 2 that is installed on an installation surface; a first arm 3 supported by the base 2; a second arm 4 supported by the first arm 3; and a shaft 5 supported by the second arm 4.

The base 2 is connected to a controller (not shown) by means of a cable 6 and is connected to the second arm 4 by means of a cable 7. The controller supplies a control signal and power to a first servomotor 8 in the base 2 via the cable 6. In addition, the controller supplies control signals and power to a second servomotor 9, a third servomotor 10, and a fourth servomotor (not shown) in the second arm 4 via the cables 6 and 7. Reference signs 11 and 12 indicate reducers.

An end portion of the first arm 3 is supported by the base 2 so as to be pivotable the horizontal direction. The first arm 3 is pivoted, by means of the first servomotor 8, about a vertical-direction first axis A with respect to the base 2. An end portion of the second arm 4 is supported by the other end portion of the first arm 3 so as to be pivotable in the horizontal direction. The second arm 4 is pivoted, by means of the second servomotor 9, about a second axis B with respect to the first arm 3. The second axis B is parallel to the first axis A. The shaft 5 passes through the other end portion of the second arm 4 in the vertical direction, and is supported by the second arm 4 so as to be linearly movable along a third axis C and rotatable about the third axis C. The third axis C is parallel to the first axis A and the second axis B, and is aligned with the longitudinal axis of the shaft 5.

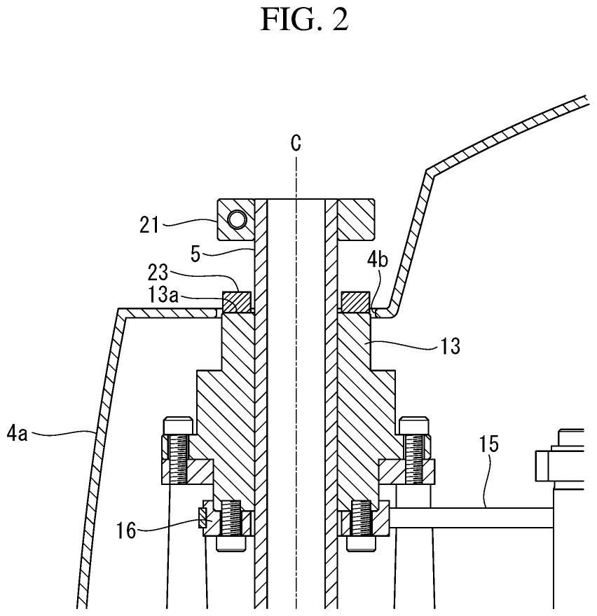

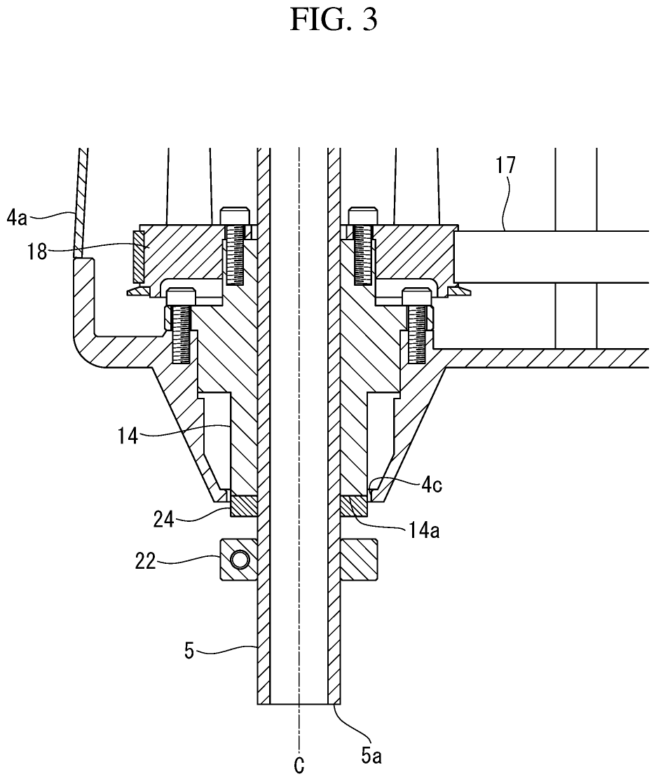

As shown in FIGS. 1 to 3, a ball screw nut 13 and a ball spline nut 14 that individually support the shaft 5 are provided in the interior of the second arm 4. The ball screw nut 13 and the ball spline nut 14 are supported by means of bearings (not shown) so as to be rotatable about the third axis C with respect to the second arm 4. The shaft 5 is moved in the vertical direction along the third axis C as a result of the ball screw nut 13 being rotated about the third axis C due to the rotation of the third servomotor 10 transmitted to the ball screw nut 13 by a belt 15 and a pulley 16. The shaft 5 is rotated about the third axis C as a result of the ball spline nut 14 being rotated about the third axis C due to the rotation of the fourth servomotor transmitted to the ball spline nut 14 by a belt 17 and a pulley 18.

In addition, the horizontal articulated robot 1 includes two stoppers 21 and 22 attached to the shaft 5, a buffering member 23 secured to a counterpart member of the stopper 21, and a buffering member 24 secured to a counterpart member of the stopper 22. The counterpart member of the stopper 21 is a member that is provided in the second arm 4 and that faces the stopper 21 in the vertical direction. The counterpart member of the stopper 22 is a member that is provided in the second arm 4 and that faces the stopper 22 in the vertical direction. In the example in FIGS. 1 to 3, holes 4b and 4c through which the shaft 5 passes are respectively provided in a top surface and a bottom surface of a cover 4a of the second arm 4. A top-end surface 13a of the ball screw nut 13 is exposed outside the cover 4a via the hole 4b, and a bottom-end surface 14a of the ball spline nut 14 is exposed outside the cover 4a via the hole 4c. In an example, the counterpart member of the upper-side stopper 21 is the ball screw nut 13, and the counterpart member of the lower-side stopper 22 is the ball spline nut 14.

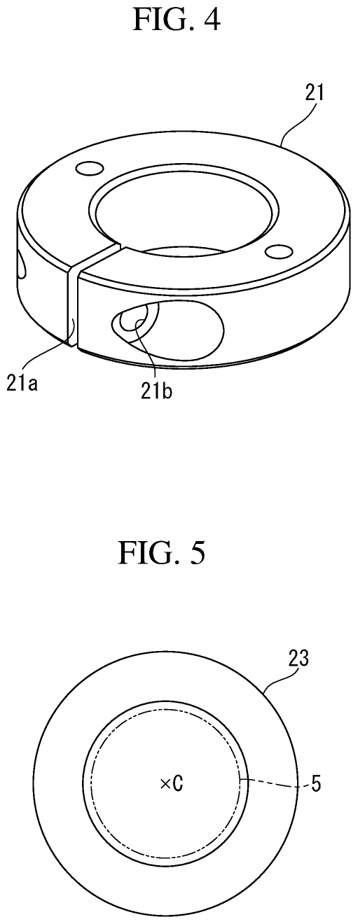

As shown in FIG. 4, the individual stoppers 21 and 22 are annular or cylindrical members secured to outer circumferential surface of the shaft 5 and are formed from a high-rigidity material such as a metal. The stopper 21 is secured to a top end portion of the shaft 5 and the stopper 22 is secured to a bottom end portion of the shaft 5.

For example, the stopper 21 has a slit 21a that splits the stopper 21 in a circumferential direction and a bolt hole 21b that is orthogonal to the slit 21a. As a result of fastening a bolt into the bolt hole 21b in a state in which the stopper 21 is disposed in the periphery of the shaft 5, the stopper 21 can be secured to the shaft 5 by means of friction between an inner circumferential surface of the stopper 21 and the outer circumferential surface of the shaft 5 by decreasing the inner diameter of the stopper 21. As with the stopper 21, the stopper 22 also has a slit and a bolt hole and is secured to the shaft 5 by means of friction. The stoppers 21 and 22 may be secured to the shaft 5 by another means such as welding.

The movement of the shaft 5 in the vertical direction with respect to the second arm 4 is mechanically restricted within a prescribed movable range by means of the two stoppers 21 and 22 provided at the upper side and the lower side of the second arm 4. Specifically, as a result of the upper-side stopper 21 abutting the counterpart member 13 of the second arm 4, further lowering of the shaft 5 is restricted. As a result of the lower-side stopper 22 abutting the counterpart member 14 of the second arm 4, further raising of the shaft 5 is restricted.

The individual buffering members 23 and 24 are formed from an elastic material such as a rubber, a sponge, or a foam body. The upper-side buffering member 23 is secured to the top-end surface 13a of the ball screw nut 13, which is the counterpart member of the upper-side stopper 21, and is disposed between the stopper 21 and the ball screw nut 13. The lower-side buffering member 24 is secured to the bottom-end surface 14a of the ball spline nut 14, which is the counterpart member of the lower-side stopper 22, and is disposed between the stopper 22 and the ball spline nut 14.

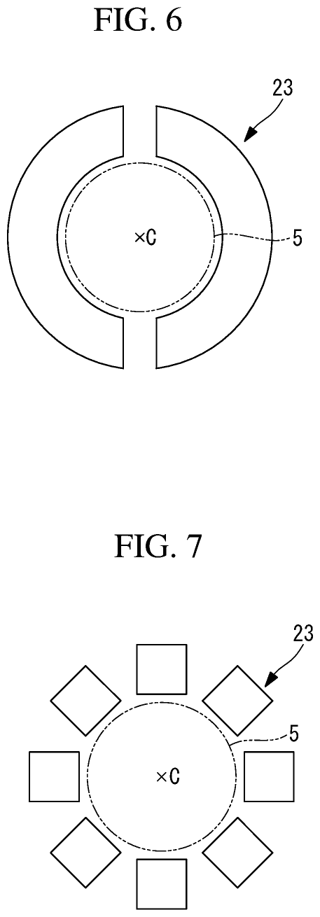

FIGS. 5 to 7 show examples of the shape and arrangement of the buffering member 23, 24. The buffering member 23, 24 is substantially evenly arranged on the circumference surrounding the shaft 5. For example, as shown in FIG. 5, the buffering member 23, 24 may be a single annular member that is disposed over the entire circumference in the periphery of the shaft 5. Alternatively, as shown in FIGS. 6 and 7, the buffering member 23, 24 may be configured with a plurality of members that are substantially evenly arrayed in the periphery of the shaft 5.

The controller supplies the first, second, and third servomotors 8, 9, and 10, as well as the fourth servomotor with the control signals and power in accordance with an operating program, and thus, controls motions of the first arm 3, the second arm 4, and the shaft 5. As shown in FIG. 1, a stroke range S of the shaft 5 in the vertical direction is set in the operating program. The controller controls the movement of the shaft 5 in the vertical direction within the stroke range S. Each of the stoppers 21 and 22 is secured to the shaft 5 at a position at which the stopper 21 or 22 comes into contact with the counterpart member 13 or 14 when the shaft 5 is moved beyond a limit S1 or S2 of the stroke range S.

Next, the operation of the horizontal articulated robot 1 will be described. With the horizontal articulated robot 1, the position of a wrist portion 5a at a tip of the shaft 5 is two-dimensionally changed in a horizontal direction as a result of the first arm 3 being pivoted about the first axis A and the second arm 4 being pivoted about the second axis B. In addition, the position of the wrist portion 5a is changed in a vertical direction as a result of the shaft 5 being linearly moved along the third axis C, and the orientation of the wrist portion 5a is changed about the third axis C as a result of the shaft 5 being rotated about the third axis C.

The vertical movement of the shaft 5 is restricted, by means of the controller, within the stroke range S set in the operating program. So long as the shaft 5 is moved within the stroke range S, the stoppers 21 and 22 do not interfere with the counterpart members 13 and 14 and the buffering members 23 and 24. However, the shaft 5 is sometimes moved beyond the normal stroke range S in the case in which the moving range of the shaft 5 is not normally restricted by the controller, caused by erroneous setting of the stroke range S in the operating program or the like. At this time, the stoppers 21 and 22 mechanically restrict the movement of the shaft 5.

Specifically, when the shaft 5 is about to be lowered beyond the lower limit S2 of the stroke range S, further lowering of the shaft 5 is prevented as a result of the upper-side stopper 21 abutting the top-end surface 13a of the ball screw nut 13 via the buffering member 23. When the shaft 5 is about to be raised beyond the upper limit S1 of the stroke range S, further raising of the shaft 5 is prevented as a result of the lower-side stopper 22 abutting the bottom-end surface 14a of the ball spline nut 14 via the buffering member 24.

If the stoppers 21 and 22 directly collide with the counterpart members 13 and 14 when the heavy shaft 5 is linearly moving at a high speed, the stoppers 21 and 22 and the counterpart members 13 and 14 are subjected to high impacts, and thus, the stoppers 21 and 22 and the counterpart members 13 and 14 may be damaged. For example, in the case in which the stoppers 21 and 22 are secured to the shaft 5 by means of friction, the positions of the stoppers 21 and 22 may be shifted or the stoppers 21 and 22 may fall off from the shaft 5 due to the high impacts. In addition, the nuts 13 and 14 could fail to move normally, as a result of the impacts forming indentations in ball rolling surfaces of the nuts 13 and 14 or the shaft 5.

With this embodiment, the impacts are absorbed by elastic compression of the buffering member 23 between the stopper 21 and the counterpart member 13, thus buffering the impacts exerted on the stopper 21 and the counterpart member 13. In addition, the impacts are absorbed by elastic compression of the buffering member 24 between the stopper 22 and the counterpart member 14, thus buffering the impacts exerted on the stopper 22 and the counterpart member 14. By doing so, it is possible to prevent the stoppers 21 and 22 and the counterpart members 13 and 14 from being damaged, and thus, it is possible to enhance the reliability of the horizontal articulated robot 1.

In addition, because the buffering members 23 and 24 are substantially evenly disposed over the entire circumference in the periphery of the shaft 5, the impacts exerted on the stoppers 21 and 22 and the counterpart members 13 and 14 are spatially evenly dispersed. By doing so, it is possible to more reliably prevent the stoppers 21 and 22 and the counterpart members 13 and 14 from being damaged. In particular, it is possible to prevent the formation of indentations in the ball rolling surfaces. In addition, because increases in the size and the weight of the stoppers 21 and 22 could affect the operation of the horizontal articulated robot 1, it is preferable that the stoppers 21 and 22 be small and light. With this embodiment, the buffering members 23 and 24 are separate components from the stoppers 21 and 22, and are secured to the counterpart members 13 and 14 provided in the second arm 4. Therefore, it is possible to add the buffering members 23 and 24 to the horizontal articulated robot 1 without affecting the operation of the shaft 5.

In this embodiment, although the buffering members 23 and 24 are disposed on the end surfaces 13a and 14a of the counterpart members 13 and 14, alternatively, the buffering members may be disposed away from the end surfaces 13a and 14a in the vertical direction. In this case, the buffering members are secured to the counterpart members 13 and 14 at surfaces other than the end surfaces 13a and 14a of the counterpart members 13 and 14 facing the stoppers 21 and 22, or to securing members that are provided in the second arm 4 and that are different from the counterpart members 13 and 14.

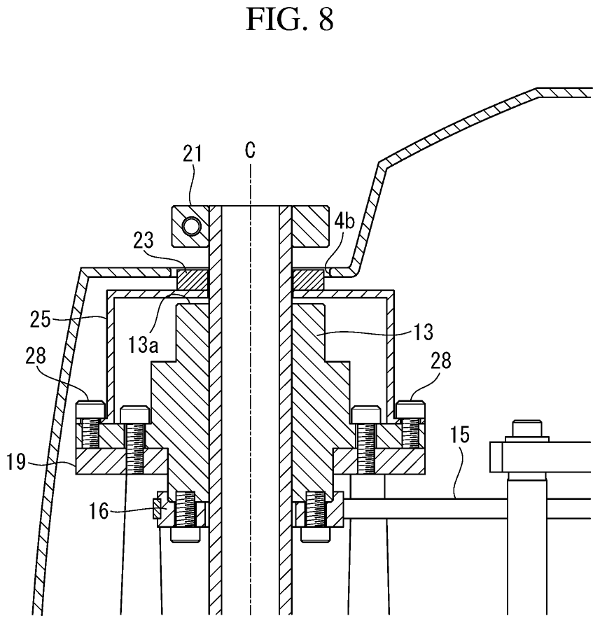

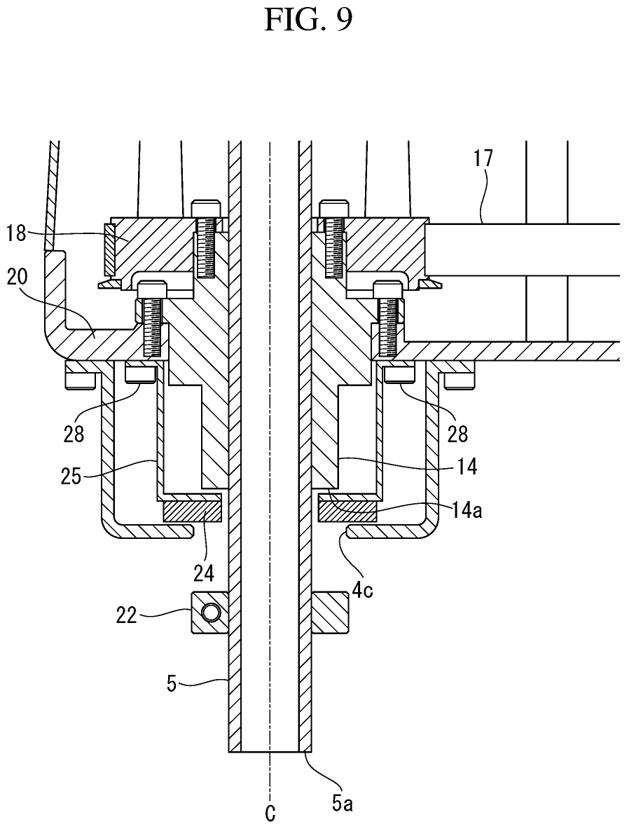

The securing members are members that are secured to the cover 4a or members that are disposed in the second arm 4 and secured with respect to the cover 4a. In an example, the securing members are supporting members 19 and 20 that are secured to the cover 4a and that respectively support the nuts 13 and 14 in a rotatable manner, as shown in FIGS. 8 and 9.

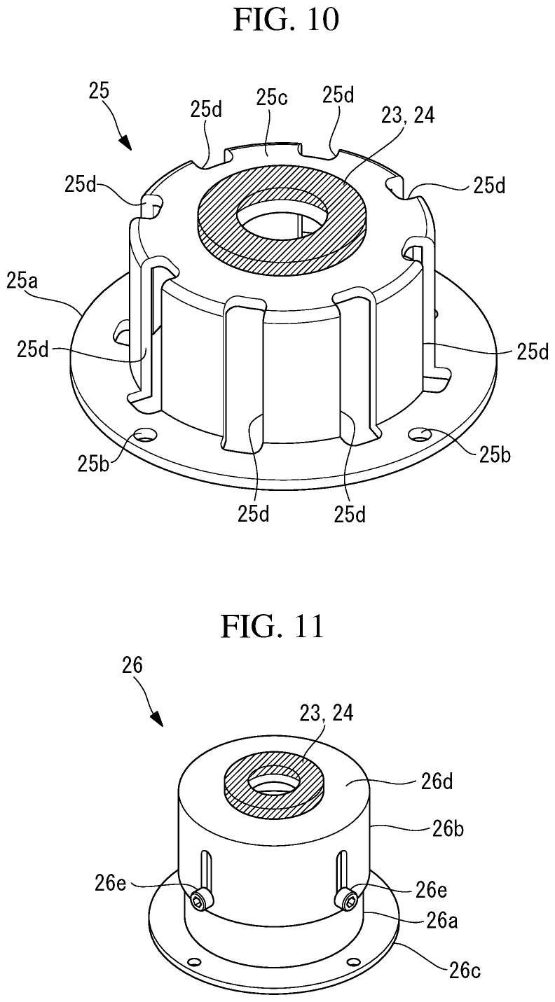

FIG. 10 shows an example of a buffering member 25 that is secured to the supporting member 19, 20. The buffering member 25 is a cylindrical member that is disposed substantially coaxially with the shaft 5. At one end of the buffering member 25, a flange 25a that expands radially outward is provided. The flange 25a is a portion to be secured to the supporting member 19, 20, and a plurality of holes 25b into which bolts 28 are inserted are provided therein. At the other end of the buffering member 25, an annular end wall 25c that faces the stopper 21 or 22 is provided. The end wall 25c is disposed away from the counterpart member 13, 14 in the vertical direction. The buffering member 25 is formed of, for example, a cast product or a sheet metal, and absorbs an impact by being plastically deformed as a result of a collision with the stopper 21 or 22. In order to increase the impact absorption, the end wall 25c may additionally be provided with a buffering member 23 or 24 formed of an elastic material.

As a result of disposing the buffering members 25 away from the end surfaces 13a and 14a of the counterpart members 13 and 14 in the vertical direction, spaces are formed between the buffering members 25 and the end surfaces 13a and 14a. With these spaces, it is possible to reduce impacts exerted on the counterpart members 13 and 14 from the stoppers 21 and 22. Furthermore, as a result of the buffering members 25 being secured to the securing members 19 and 20, which are different from the counterpart members 13 and 14, it is possible to more effectively reduce the impacts exerted on the counterpart members 13 and 14 from the stoppers 21 and 22. The same effect is afforded in the case in which the buffering members 25 are secured to the counterpart members 13 and 14 at surfaces other than the end surfaces 13a and 14a.

In addition, because the buffering members 25 are mechanically secured to the securing members 19 and 20 by means of the bolts 28, the buffering members 25 are attachable to the securing members 19 and 20 and detachable therefrom. Therefore, after the buffering members 25 are damaged due to collisions with the stoppers 21 and 22, it is possible to easily replace the damaged buffering members 25 with new buffering members 25.

The buffering member 25 may have a structure that facilitates plastic deformation due to a collision with the stopper 21 or 22. For example, as shown in FIG. 10, the buffering member 25 may have a plurality of slits 25d extending in the vertical direction in a side wall, thus facilitating deformation in the vertical direction. Alternatively, the buffering member 25 may have, in an intermediate portion of the side wall, a low-rigidity portion having a lower rigidity than other portions do, thus being configured so as to buckle at the low-rigidity portion.

As shown in FIG. 11, a buffering member 26 may be formed from two members 26a and 26b that allow the relative positions thereof to be changed in the vertical direction. The member 26a is a fixed portion secured to each of the securing members 19 and 20, and is, for example, a cylindrical member having a flange 26c similar to the flange 25a. The member 26b is a movable portion that allows the position thereof to be changed in the vertical direction with respect to the fixed portion 26a, and is, for example, a cylindrical member having an end wall 26d similar to the end wall 25c. The fixed portion 26a and the movable portion 26b are disposed in a nested manner with each other, and, by doing so, it is possible to extend and contract the buffering member 26 in the vertical direction in a telescopic manner. The movable portion 26b is secured to the fixed portion 26a by means of, for example, screws 26e.

With such a buffering member 26, it is possible to adjust the position of the movable portion 26b in the vertical direction by changing the position of the movable portion 26b with respect to the fixed portion 26a. By doing so, it is possible to easily adjust the position at which the stopper 21, 22 collides with the buffering member 26 by changing the distances between the stopper 21, 22 and the buffering member 26.

In the above-described embodiment, although two sets of stoppers 21 and 22 and buffering members 23 and 24 are provided, one set each on the upper side and the lower side of the second arm 4, alternatively, one set consisting of a stopper and a buffering member may be provided only on one of the upper side and the lower side of the second arm 4.

1. A horizontal articulated robot comprising:
a base;
a first arm that is supported by the base so as to be pivotable in a horizontal direction;
a second arm that is supported by the first arm so as to be pivotable in the horizontal direction;
a shaft that is supported by the second arm so as to be linearly movable in a vertical direction along a longitudinal axis;
a stopper that is attached to the shaft and that restricts a movement of the shaft in the vertical direction within a movable range; and
a buffering member that is provided in the second arm,
wherein the buffering member is disposed between the stopper and a counterpart member that is provided in the second arm and that faces the stopper in the vertical direction, and buffers an impact exerted on the counterpart member from the stopper.

2. The horizontal articulated robot according to claim 1, wherein the buffering member is disposed on an end surface of the counterpart member facing the stopper.

3. The horizontal articulated robot according to claim 1, wherein the buffering member is disposed with a spacing in the vertical direction from the end surface of the counterpart member facing the stopper.

4. The horizontal articulated robot according to claim 1, wherein the buffering member is secured to the counterpart member.

5. The horizontal articulated robot according to claim 1, wherein the buffering member is secured to a securing member that is provided in the second arm and that is different from the counterpart member.

6. The horizontal articulated robot according to claim 1, wherein the buffering member is plastically deformed due to a collision with the stopper.

7. The horizontal articulated robot according to claim 1, wherein the buffering member is attachable to a member provided in the second arm and detachable therefrom.

8. The horizontal articulated robot according to claim 1, wherein the buffering member comprises:
a fixed portion secured to the securing member; and
a movable portion that is disposed between the counterpart member and the stopper and that allows a position thereof with respect to the fixed portion to be changed in the vertical direction.
